(19) United States
(12) Patent Application Publication
(10) Pub. No.: US 2006/0166082 A1
(43) Pub. Date: Jul. 27, 2006

(54) Battery operated electric blanket

(76) Inventors: Regina Gale Turner, Union City, TN (US); Thomas Dishons Turner, Union City, TN (US)

Correspondence Address: GALASSO & ASSOCIATES, LP, P.O. Box 26503, Austin, TX, 78755-0503, US

(21) Appl. No.: 11/321,181

(22) Filed: Dec. 29, 2005

Related U.S. Application Data
(60) Provisional application No. 60/640,769, filed on Dec. 31, 2004.

(51) Int. Cl. H01M 2/10; H05B 1/00

(52) U.S. Cl. 429/96; 429/61; 429/99; 219/212

(57) ABSTRACT

A battery powered electric blanket includes battery compartments are located on each of the four corners and are configured to facilitate the removal and insertion of batteries. The batteries are used to power a network of heating elements distributed through out the blanket. The blanket is further designed such that is could also be powered by an external AC or DC power source, and at that same time recharge the batteries in the battery compartments. The blanket also includes a user operable controller to set and control the desired level of heat generated during operation.

### PRIORITY UNDER 35 U.S.C. §119(e) & 37 C.F.R. §1.78

This nonprovisional application claims priority based upon the following prior U.S. provisional patent entitled: B.O. blanket, Application No. 60/640,769, file Dec. 31, 2004, in the name of Regina Gale Turner, which is hereby incorporated by reference for all purposes.

### FIELD OF THE INVENTION

The present invention relates to electric blankets, and more specifically but not by way of limitation, to a portable electric blanket that is powered through the use of battery compartments integrated into the blanket.

### BACKGROUND

Electric blankets have been around for some time. Most electric blankets are designed only for indoor home use. These electric blankets are designed to be powered by standard AC outlets and will not work if not plugged-in. In this environment, the standard electric blanket works well. However, as can be appreciated, there is a need to use electric blankets beyond indoor home use. This would include during outdoor sporting events, vehicle trips, camping and other activities where a standard AC outlet is not readily accessible.

Accordingly there is a need for an electric blanket that can be readily powered by an alternative power supply and further be designed to facilitate use outdoors.

### SUMMARY OF THE INVENTION

The present invention is an electric blanket that is powered through the use of batteries stored in battery compartments integrated into the blanket. The blanket is made of materials to facilitate the use of the electric blanket outdoors. Battery compartments are located on each of the four corners and are configured to facilitate the removal and insertion of batteries. The batteries are used to power a network of heating elements distributed through out the blanket. The blanket is further designed such that is could also be powered by an external AC or DC power source, and at that same time recharge the batteries in the battery compartments. The blanket also includes a user operable controller to set and control the desired level of heat generated during operation.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 illustrates a top perspective view of an embodiment of the present invention with a portion removed illustrating internal portions; and

FIG. 2 illustrates an enlarged partial top perspective view of a battery compartment with a battery pack removed therefrom.

### DETAILED DESCRIPTION

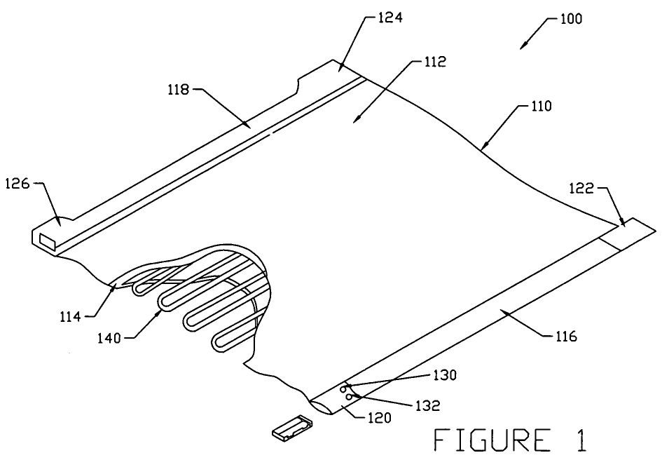

Referring now to the drawings, wherein various elements depicted are not necessarily drawn to scale, and in particular FIG. 1 there is illustrated an electric blanket 100 constructed according to the principles of the present invention.

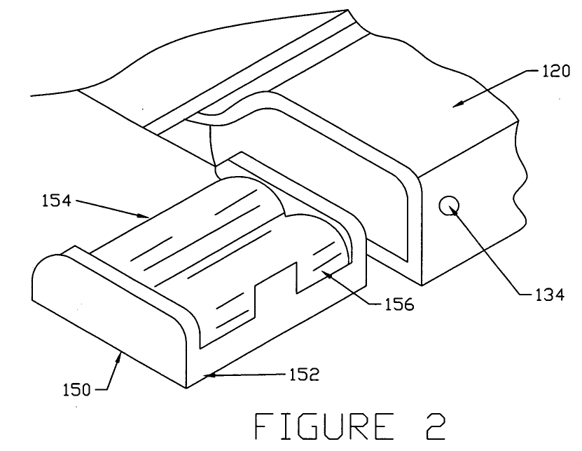

As illustrated electric blanket 100 includes a blanket portion 110, bindings 116 and 118, and battery compartments 120, 122, 124 and 126. Each of the battery compartments 120, 122, 124 and 126 are configured to receive a battery pack, such as battery back 150 (see FIG. 2). Electric blanket 100 further includes a heating element 140 disposed substantially therein.

As illustrated in FIG. 1, blanket portion 110 of electric blanket 100 is generally made up of two portions, an upper portion 112 and a lower portion 114. Upper portion 112 and lower portion 114 are configured such that heating element 140 is disposed intermediate upper portion 112 and lower portion 114. It is contemplated that blanket portion 110 could be comprised of either a folded single piece of material to form upper portion 112 and lower portion 114, or could be comprised of two or more separate pieces connected together to form upper portion 112 and lower portion 114.

Heating element 140 is disposed substantially throughout electric blanket 100 and is configured to be electrically connected to and controlled battery compartments 120, 122, 124 and 126.

Bindings 116 and 118 are configured to trim out electric blanket 100 and are further configured to contain or house battery compartments 120, 122, 124 and 126. Good results have been achieved by constructing bindings 116 and 118 out of lace produced from a durable, lightweight fabric.

As further illustrated, battery compartment 120 includes and on/off switch 130 and a controller 132. On/off switch 130 allows a user to switch electric blanket 100 between an on mode, whereby power is supplied to heating element 140, and an off mode, whereby power is not supplied to heating element 140. Controller 132 allows a user to select a desired operating level or temperature for electric blanket 100.

External power outlet 134 is configured to receive an external power source, such as from a DC or AC power supply. Battery compartment 120 is further configured, such that if an external power source is connected to outlet 134 and rechargeable batteries are being used, the rechargeable batteries disposed in each of the battery compartments could be recharged. This enables a user to recharge all the batteries without having to remove them.

Although it is contemplated that electric blanket 100 could be virtually any shape, and could be constructed from various materials, good results have been achieved by constructing electric blanket 100 in a large, rectangular shape in various standard sizes, such as full, queen and king sizes. Good results have also been achieved by utilizing cotton or wool materials such that electric blanket 100 can be easily washed or dry-cleaned.

Referring now in particular to FIG. 2, there is illustrated an enlarged partial view of battery compartment 120 with a battery pack 150 shown removed therefrom. As illustrated battery pack 150 includes a frame 152 configured to receive batteries 154 and 156. Battery pack 150 is configured to be inserted into and removably secured within battery compartment 120 and form an electrical connection therebetween. It is contemplated that each of the other battery compartments 122, 124 and 126 are configured in a similar manner to that of battery compartment 120 and each can receive therein a battery pack similar to that of battery pack 150. Although it is contemplated that virtually any size of battery could be used for batteries 154 and 156, good results have been achieved utilizing standard or rechargeable AA size batteries.

As briefly described herein, external power outlet 134 is configured to receive power from an external power AC or DC power source, such that if an external power source is connected to outlet 134 and rechargeable batteries are being used, the rechargeable batteries disposed in each of the battery compartments could be recharged. Additionally electrical blanket 100 could be powered by an external power source where available to preserve the life of the batteries. Such a case might be if a user has electric blanket 100 in a vehicle and a 12V DC outlet was available to supply power to electric blanket 100.

An example of the operation of electric blanket 100 will now be described with reference to using only batteries. A user loads batteries into each of the battery packs, such as batteries 154 and 156 and battery pack 150. Each battery pack is then inserted into a corresponding one of battery compartments 120, 122, 124 and 126. The user sets the desired operating level via controller 132 and turns on electric blanket 100 via on/off switch 130. The user then drapes or wraps electric blanket 100 around at least a part of their body. The heating element 140 heats up and supplies warmth to the user.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An electric blanket, comprising:
a blanket portion having an upper layer and a lower layer;
a heating element disposed intermediate said upper layer and said lower layer of said blanket portion;
at least one compartment electrically connected to said heating element;
at least one power supply; and
said at least one compartment configured to receive therein said at least one power supply such that said at least one power supply is operable to supply power to said heating element to produce heat.

2. The electric blanket as recited in claim 1, wherein said at least one compartment includes a switch to switch the electric blanket between an on mode and an off mode.

3. The electric blanket as recited in claim 1, wherein said at least one compartment includes a controller, said controller operable to control the amount of power supplied by said at least one power supply to said heating element.

4. The electric blanket as recited in claim 1, wherein said at least one power supply includes a battery.

5. The electric blanket as recited in claim 1, wherein said at least one power supply includes a rechargeable battery.

6. The electric blanket as recited in claim 1, and further including at least a second compartment, said second compartment electrically connected to said at least one compartment, said second compartment for receiving therein at least a second power supply.

7. The electric blanket as recited in claim 1, wherein said at least one compartment includes an adapter for receiving power from an external power supply.

8. A battery operated electric blanket, comprising:
a blanket portion having an upper layer and a lower layer;
a heating element disposed intermediate said upper layer and said lower layer of said blanket portion;
a first compartment electrically connected to said heating element, said first compartment configured to receive therein at least one battery such that said at least one battery is operable to supply power to said heating element to produce heat.

9. The battery operated electric blanket as recited in claim 8, wherein said first compartment includes a switch to switch the battery operated electric blanket between an on mode and an off mode.

10. The battery operated electric blanket as recited in claim 8, wherein said first compartment includes a controller, said controller operable to control the amount of power supplied by the at least one battery to said heating element.

11. The battery operated electric blanket as recited in claim 8, and further including a second compartment electrically connected to said first compartment, said second compartment configured to receive therein at least one battery.

12. The battery operated electric blanket as recited in claim 8, wherein said first compartment includes an adapter for receiving power from an external power supply.

13. The battery operated electric blanket as recited in claim 12, wherein said first compartment being operable to recharge the at least one battery disposed therein from power received from the external power supply.

14. The battery operated electric blanket as recited in device as recited in claim 11, and further including a third compartment electrically connected to said first compartment and a fourth compartment electrically connected to said first compartment, each of said third compartment and said fourth compartment configured to receive therein at least one battery.

15. An electric blanket, comprising:
a blanket portion having an upper layer and a lower layer;
a heating element disposed intermediate said upper layer and said lower layer of said blanket portion;
a plurality of compartments being electrically connected to said heating element;
a plurality of power packs; and
each of said plurality of compartments being configured to receive one of said plurality of power packs, such that each of said plurality of power packs being operable to supply power to said heating element to produce heat.

16. The electric blanket as recited in claim 15, wherein one of said plurality of compartment includes a switch to switch the electric blanket between an on mode and an off mode.

17. The electric blanket as recited in claim 16, wherein said one of said plurality of compartment includes a variable controller, said variable controller operable to control the amount of power supplied by said plurality of power packs to said heating element.

18. The electric blanket as recited in claim 17, wherein each of said plurality of power packs includes at least one battery.

19. The electric blanket as recited in claim 18, wherein each of said plurality of power packs includes at least one rechargeable battery.

20. The electric blanket as recited in claim 19, wherein said one of said plurality of compartments includes an adapter for receiving power from an external power supply, and further said one of said plurality of compartments operable to recharge each of said rechargeable batteries from power received from the external power supply.
